(19) United States
(12) Patent Application Publication
(10) Pub. No.: US 2014/0044961 A1
(43) Pub. Date: Feb. 13, 2014

(54) PRESSURE-SENSITIVE ADHESIVE, PRESSURE-SENSITIVE ADHESIVE LAYER, AND PRESSURE-SENSITIVE ADHESIVE SHEET

(71) Applicant: NITTO DENKO CORPORATION, Osaka (JP)

(72) Inventors: Yoshihito TAKAMI, Osaka (JP); Hirofumi KATAMI, Osaka (JP); Hiroaki KISHIOKA, Osaka (JP)

(73) Assignee: NITTO DENKO CORPORATION, Osaka (JP)

(21) Appl. No.: 13/962,474

(22) Filed: Aug. 8, 2013

(30) Foreign Application Priority Data
Aug. 9, 2012 (JP) 2012-177154

(51) Int. Cl. C08F 220/10; C09J 7/02

(52) U.S. Cl. CPC C08F 220/10; C09J 7/0217
USPC 428/355 AC; 526/263; 526/309

(57) ABSTRACT

A pressure-sensitive adhesive capable of forming a pressure-sensitive adhesive layer with high transparency and low sebum-induced swelling rate is provided, which includes a (meth)acryl-based polymer obtained by polymerization of a monomer component containing 40 to 82% by weight of an alkyl(meth)acrylate having an alkyl group of 4 to 18 carbon atoms at the ester end and 18 to 35% by weight of a hydroxyl group-containing monomer.

### TECHNICAL FIELD

The invention relates to a pressure-sensitive adhesive capable of forming a pressure-sensitive adhesive layer with a high level of transparency and a low level of sebum-induced swelling rate. The invention also relates to a pressure-sensitive adhesive layer obtained from such a pressure-sensitive adhesive and to a pressure-sensitive adhesive sheet including a support and such a pressure-sensitive adhesive layer provided on at least one side of the support.

### BACKGROUND ART

Recent years have seen widespread use of input devices based on a combination of an image display device and a touch panel, such as cellular phones and portable music players. There are many known transparent conductive films for use in touch panels. Such transparent conductive films include a laminate of a transparent plastic film substrate or a glass sheet and a transparent conductive thin film (ITO film), and are designed to be placed on other members with a pressure-sensitive adhesive layer interposed therebetween.

There are various known types of pressure-sensitive adhesive layers for use on such optical members (see, for example, Patent Documents 1 to 3).

### PRIOR ART DOCUMENTS

### Patent Documents

Patent Document 1: JP-A-2003-238915
Patent Document 2: JP-A-2003-342542
Patent Document 3: JP-A-2004-231723

### SUMMARY OF THE INVENTION

### Problems to be Solved by the Invention

The touch panels, which are touched with a bare finger or fingers all the time during operation, cannot escape the transfer of sebum from fingers to them. There is a problem in that when transferred to the touch panel surface, sebum can gradually move to an adhesive layer inside the touch panel to cause swelling of the adhesive layer.

Unfortunately, there have been no sufficient studies on such sebum-induced swelling of pressure-sensitive adhesive layers, and none of the Patent Documents disclose any study on sebum-induced swelling of adhesive layers.

It is an object of the invention to provide a pressure-sensitive adhesive capable of forming a pressure-sensitive adhesive layer with a high level of transparency and a low level of sebum-induced swelling rate.

### Means for Solving the Problems

As a result of intense investigations to solve the problems, the inventors have made the invention, based on the finding that the objects are achieved with a pressure-sensitive adhesive described below.

The invention relates to a pressure-sensitive adhesive, comprising a (meth)acryl-based polymer obtained by polymerization of a monomer component containing 40 to 82% by weight of an alkyl(meth)acrylate having an alkyl group of 4 to 18 carbon atoms at an ester end and 18 to 35% by weight of a hydroxyl group-containing monomer.

In the pressure-sensitive adhesive, the hydroxyl group-containing monomer is preferably hydroxyalkyl(meth)acrylate having a hydroxyalkyl group of 2 to 6 carbon atoms.

In the pressure-sensitive adhesive, the hydroxyl group-containing monomer is preferably 2-hydroxyethyl(meth)acrylate and/or 4-hydroxybutyl(meth)acrylate.

In the pressure-sensitive adhesive, the alkyl(meth)acrylate having an alkyl group of 4 to 18 carbon atoms at the ester end is preferably 2-ethylhexyl(meth)acrylate or butyl(meth)acrylate.

In the pressure-sensitive adhesive, the monomer component preferably further contains a cyclic nitrogen-containing monomer.

In the pressure-sensitive adhesive, the monomer component preferably further contains 3% by weight or less of a polyfunctional monomer.

The invention also relates to a pressure-sensitive adhesive layer obtained from the pressure-sensitive adhesive.

The pressure-sensitive adhesive layer preferably has a gel fraction of 95% by weight or less.

The pressure-sensitive adhesive layer preferably has a haze of 2% or less when it has a thickness of 100 μm.

The pressure-sensitive adhesive layer preferably has a sebum-induced swelling rate of less than 1.2.

The pressure-sensitive adhesive layer is preferably for use on an optical member.

The invention also relates to a pressure-sensitive adhesive sheet including a support and the pressure-sensitive adhesive layer formed on at least one side of the support.

The pressure-sensitive adhesive sheet is preferably a pressure-sensitive adhesive optical member including an optical member as the support and the pressure-sensitive adhesive layer provided on at least one side of the optical member.

### Effect of the Invention

The pressure-sensitive adhesive of the invention can provide both a high level of transparency and a low level of sebum-induced swelling rate because it includes a (meth)acryl-based polymer obtained by polymerization of a monomer component containing 40 to 82% by weight of an alkyl(meth)acrylate having an alkyl group of 4 to 18 carbon atoms at the ester end and 18 to 35% by weight of a hydroxyl group-containing monomer.

### BRIEF DESCRIPTION OF THE DRAWINGS

FIG. 1 is a drawing showing an example of a capacitance touch panel having the pressure-sensitive adhesive layer or the pressure-sensitive adhesive sheet of the invention.

### MODE FOR CARRYING OUT THE INVENTION

### 1. Pressure-Sensitive Adhesive

The pressure-sensitive adhesive of the invention contains a (meth)acryl-based polymer obtained by polymerization of a monomer component containing 40 to 82% by weight of an alkyl(meth)acrylate having an alkyl group of 4 to 18 carbon atoms at the ester end and 18 to 35% by weight of a hydroxyl group-containing monomer. As used herein, the term “alkyl(meth)acrylate” refers to alkyl acrylate and/or alkyl methacrylate, and “(meth)” is used in the same meaning in the description.

An alkyl(meth)acrylate having a preferred alkyl group may be selected as needed depending on the method for producing the (meth)acryl-based polymer, although the alkyl group has 4 to 18 carbon atoms. For example, when the (meth)acryl-based polymer is produced by solution polymerization or the like, the alkyl group preferably has 4 to 16 carbon atoms, more preferably 8 to 14 carbon atoms. When the (meth)acryl-based polymer is produced by radiation polymerization or the like, the alkyl group preferably has 4 to 18 carbon atoms.

Although the alkyl group of 4 to 18 carbon atoms in the alkyl(meth)acrylate to be used may be any of a strain chain and a branched chain, the alkyl group is preferably a branched chain in view of forming a pressure-sensitive adhesive layer with a lower dielectric constant.

Examples of the alkyl(meth)acrylate having a straight-chain alkyl group of 4 to 18 carbon atoms at the ester end include n-butyl(meth)acrylate, n-pentyl(meth)acrylate, n-hexyl(meth)acrylate, n-heptyl(meth)acrylate, n-octyl(meth)acrylate, n-nonyl(meth)acrylate, n-decyl(meth)acrylate, n-undecyl(meth)acrylate, n-dodecyl(meth)acrylate, n-tridecyl(meth)acrylate, n-tetradecyl(meth)acrylate, n-pentadecyl(meth)acrylate, n-hexadecyl(meth)acrylate, n-heptadecyl(meth)acrylate, and n-octadecyl(meth)acrylate. Examples of the alkyl(meth)acrylate having a branched alkyl group of 4 to 18 carbon atoms at the ester end include tert-butyl(meth)acrylate, isobutyl(meth)acrylate, isopentyl (meth)acrylate, tert-pentyl(meth)acrylate, neopentyl(meth)acrylate, isohexyl(meth)acrylate, isoheptyl(meth)acrylate, 2-ethylhexyl(meth)acrylate, isooctyl(meth)acrylate, isononyl(meth)acrylate, isodecyl(meth)acrylate, 2-propylheptyl(meth)acrylate, isoundecyl(meth)acrylate, isododecyl(meth)acrylate, isotridecyl(meth)acrylate, isomyristyl(meth)acrylate, isopentadecyl(meth)acrylate, isohexadecyl(meth)acrylate, isoheptadecyl(meth)acrylate, and isostearyl(meth)acrylate. Any of these (meth)acrylates may be used alone or in combination of two or more. Among them, alkyl(meth)acrylates having an alkyl group of 4 to 9 carbon atoms are preferred, and n-butyl(meth)acrylate and 2-ethylhexyl(meth)acrylate are particularly preferred.

The monomer component used to form the (meth)acryl-based polymer contains 40 to 82% by weight, preferably 50 to 70% by weight of the alkyl(meth)acrylate having an alkyl group of 4 to 18 carbon atoms at the ester end. When the content falls within the range, a reduction in dielectric constant and a reduction in sebum-induced swelling rate can be achieved at the same time.

The hydroxyl group-containing monomer to be used may be of any type having an unsaturated double bond-containing polymerizable functional group, such as a (meth)acryloyl group or a vinyl group, and a hydroxyl group. Examples of the hydroxyl group-containing monomer include hydroxyalkyl(meth)acrylates such as 2-hydroxybutyl(meth)acrylate, 3-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, and 12-hydroxylauryl(meth)acrylate; and hydroxyalkylcycloalkane(meth)acrylates such as (4-hydroxymethylcyclohexyl)methyl(meth)acrylate. Other examples include hydroxyethyl(meth)acrylamide, allyl alcohol, 2-hydroxyethyl vinyl ether, 4-hydroxybutyl vinyl ether, and diethylene glycol monovinyl ether. Any of these monomers may be used alone or in combination of two or more. Among them, hydroxyalkyl(meth)acrylates are preferred. Hydroxyalkyl(meth)acrylates having a hydroxyalkyl group of 2 to 6 carbon atoms are more preferred, and 2-hydroxyethyl(meth)acrylate and/or 4-hydroxybutyl(meth)acrylate are even more preferred. In this context, the term “2-hydroxyethyl(meth)acrylate and/or 4-hydroxybutyl(meth)acrylate” means that 2-hydroxyethyl(meth)acrylate and 4-hydroxybutyl(meth)acrylate may be each used alone or may be used in combination.

The monomer component used to form the (meth)acryl-based polymer contains 18 to 35% by weight, preferably 20 to 30% by weight of the hydroxyl group-containing monomer. Setting the content of the hydroxyl group-containing monomer within the range is preferred in achieving both a high level of transparency and a low level of sebum-induced swelling rate.

The monomer component used to form the (meth)acryl-based polymer may further contain a cyclic nitrogen-containing monomer.

Any monomer having a cyclic nitrogen structure and an unsaturated double bond-containing polymerizable functional group such as a (meth)acryloyl group or a vinyl group may be used without restriction as the cyclic nitrogen-containing monomer. The cyclic nitrogen structure preferably has a nitrogen atom in the cyclic structure. Examples of the cyclic nitrogen-containing monomer include vinyl lactam monomers such as N-vinylpyrrolidone, N-vinyl-∈-caprolactam, and methylvinylpyrrolidone; and nitrogen-containing heterocyclic vinyl monomers such as vinylpyridine, vinylpiperidone, vinylpyrimidine, vinylpiperazine, vinylpyrazine, vinylpyrrole, vinylimidazole, vinyloxazole, and vinylmorpholine. The cyclic nitrogen-containing monomer may also be a (meth)acrylic monomer having a heterocyclic ring such as a morpholine ring, a piperidine ring, a pyrrolidine ring, or a piperazine ring. Examples include N-acryloyl morpholine, N-acryloyl piperidine, N-methacryloyl piperidine, and N-acryloyl pyrrolidine. Among them, vinyl lactam monomers are preferred, and N-vinylpyrrolidone is particularly preferred, in view of dielectric constant and cohesiveness.

The content of the cyclic nitrogen-containing monomer is preferably, but not limited to, 42% by weight or less, more preferably 0.5 to 30% by weight, even more preferably 0.5 to 20% by weight, based on the total weight of the monomer component used to form the (meth)acryl-based polymer. The content within the range is preferred to improve adhering strength.

The monomer component used to form the (meth)acryl-based polymer may also contain an alicyclic structure-containing monomer.

Any monomer having an alicyclic structure and an unsaturated double bond-containing polymerizable functional group such as a (meth)acryloyl group or a vinyl group may be used without restriction as the alicyclic structure-containing monomer. The alicyclic structure is a cyclic hydrocarbon structure. For a reduction in dielectric constant, the alicyclic structure preferably has 5 or more carbon atoms, preferably 6 to 24 carbon atoms, more preferably 8 to 20 carbon atoms, even more preferably 10 to 18 carbon atoms. Examples of the alicyclic structure-containing monomer include (meth)acrylic monomers such as cyclopropyl(meth)acrylate, cyclobutyl(meth)acrylate, cyclopentyl(meth)acrylate, cyclohexyl(meth)acrylate, cycloheptyl(meth)acrylate, cyclooctyl(meth)acrylate, isobornyl(meth)acrylate, dicyclopentanyl(meth)acrylate, HPMPA (Formula 1 below), TMA-2 (Formula 2 below), and HCPA (Formula 3 below). Among them, cyclohexyl(meth)acrylate, HPMPA, TMA-2, and HCPA are preferred, and cyclohexyl(meth)acrylate, HPMPA, and TMA-2 are particularly preferred.

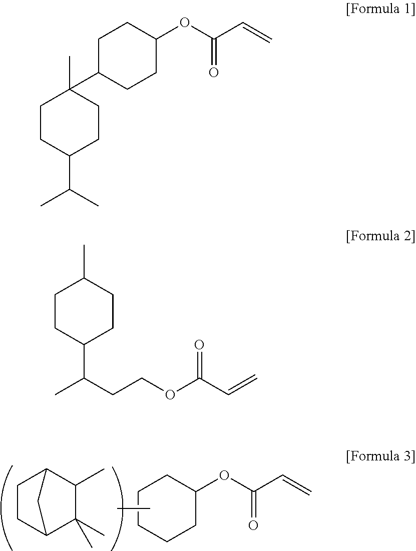

In the invention, the content of the alicyclic structure-containing monomer is preferably 42% by weight or less, more preferably 0.5 to 30% by weight, even more preferably 1 to 20% by weight, based on the total weight of the monomer component used to form the (meth)acryl-based polymer. The content within the range is preferred to improve adhering strength.

The monomer component used to form the (meth)acryl-based polymer according to the invention may further include at least one functional group-containing monomer selected from a carboxyl group-containing monomer and a cyclic ether group-containing monomer.

Any monomer having a carboxyl group and an unsaturated double bond-containing polymerizable functional group such as a (meth)acryloyl group or a vinyl group may be used without restriction as the carboxyl group-containing monomer. Examples of the carboxyl group-containing monomer include (meth)acrylic acid, carboxyethyl(meth)acrylate, carboxypentyl(meth)acrylate, itaconic acid, maleic acid, fumaric acid, crotonic acid, and isocrotonic acid. These may be used alone or in any combination. Itaconic acid or maleic acid can be used in the form of an anhydride. Among these, acrylic acid and methacrylic acid are preferred, and acrylic acid is particularly preferred. It is possible to optionally use a carboxyl group-containing monomer as the monomer component used in the production of the (meth)acryl-based polymer for use in the invention; however, it is not necessary to use a carboxyl group-containing monomer. A pressure-sensitive adhesive containing a (meth)acryl-based polymer obtained from a monomer component not containing a carboxyl group-containing monomer can form a pressure-sensitive adhesive layer that is reduced in metal corrosion due to the carboxyl group.

Any monomer having a cyclic ether group such as an epoxy group or an oxetane group and an unsaturated double bond-containing polymerizable functional group such as a (meth)acryloyl group or a vinyl group may be used without restriction as the cyclic ether group-containing monomer. Examples of the epoxy group-containing monomer include glycidyl(meth)acrylate, 3,4-epoxycyclohexylmethyl(meth)acrylate, and 4-hydroxybutyl(meth)acrylate glycidyl ether. Examples of the oxetane group-containing monomer include 3-oxetanylmethyl(meth)acrylate, 3-methyl-oxetanylmethyl(meth)acrylate, 3-ethyl-oxetanylmethyl(meth)acrylate, 3-butyl-oxetanylmethyl(meth)acrylate, and 3-hexyl-oxetanylmethyl(meth)acrylate. These monomers may be used alone or in any combination.

In the invention, the content of the functional group-containing monomer is not restricted and may be determined as needed. For example, the content of the functional group-containing monomer is preferably 35% by weight or less, more preferably 27% by weight or less, even more preferably 25% by weight or less, based on the total weight of the monomer component used to form the (meth)acryl-based polymer. To increase adhering strength and cohesive strength, the content of the functional group-containing monomer is preferably 0.5% by weight or more, more preferably 0.8% by weight or more. When the content of the functional group-containing monomer falls within the range, the adhering strength can be improved.

In the invention, the monomer component used to form the (meth)acryl-based polymer, which may contain the alkyl(meth)acrylate having an alkyl group of 4 to 18 carbon atoms at the ester end, the hydroxyl group-containing monomer, the alicyclic structure-containing monomer, and the functional group-containing monomer, may further contain a copolymerizable monomer other than these monomers. For example, such a copolymerizable monomer may be an alkyl(meth)acrylate represented by the formula: CH₂═C(R¹)COOR², wherein R¹ represents hydrogen or a methyl group, and R² represents a substituted or unsubstituted alkyl group of 1 to 3 carbon atoms.).

The alkyl(meth)acrylate represented by the formula CH₂═C(R¹)COOR² may be specifically methyl(meth)acrylate, ethyl(meth)acrylate, or the like.

The content of the alkyl(meth)acrylate represented by the formula CH₂═C(R¹)COOR² is not restricted and may be selected from any appropriate values depending on the method for producing the (meth)acryl-based polymer. For example, however, the content of the alkyl(meth)acrylate represented by the formula CH₂═C(R¹)COOR² is preferably 30% by weight or less based on the total weight of the monomer component used to form the (meth)acryl-based polymer.

Other copolymerizable monomers that may also be used include vinyl monomers such as vinyl acetate, vinyl propionate; styrene, α-methylstyrene; glycol acrylic ester monomers such as polyethylene glycol(meth)acrylate, polypropylene glycol(meth)acrylate, methoxyethylene glycol(meth)acrylate, and methoxypolypropylene glycol(meth)acrylate; and acrylate ester monomers such as tetrahydrofurfuryl(meth)acrylate, fluoro(meth)acrylate, silicone(meth)acrylate, and 2-methoxyethyl acrylate; amide group-containing monomers, amino group-containing monomers, imide group-containing monomers and vinyl ether monomers.

Besides the above, a silicon atom-containing silane monomer may be exemplified as the copolymerizable monomer. Examples of the silane monomers include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

In the invention, if necessary, the monomer component used to form the (meth)acryl-based polymer may contain a polyfunctional monomer for controlling the cohesive strength of the pressure-sensitive adhesive in addition to the monofunctional monomers listed above. As used herein, the term “monofunctional monomer” refers to a monomer having a single polymerizable functional group containing an unsaturated double bond, such as a (meth)acryloyl group or a vinyl group, and the term “polyfunctional monomer” refers to a monomer having at least two polymerizable functional groups each containing an unsaturated double bond, such as (meth)acryloyl groups or vinyl groups, as described below.

The polyfunctional monomer is a monomer having at least two polymerizable functional groups with an unsaturated double bond such as (meth)acryloyl group or vinyl group, and examples thereof include ester compounds of a polyhydric alcohol with (meth)acrylic acid (e.g., (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, 1,2-ethyleneglycol di(meth)acrylate, 1,6-hexanediol di(meth)acrylate, 1,12-dodecanediol di(meth)acrylate, trimethylolpropane tri(meth)acrylate, tetramethylolmethane tri(meth)acrylate, allyl(meth)acrylate, vinyl(meth)acrylate, divinylbenzene, epoxy acrylate, polyester acrylate, urethane acrylate, butanediol di(meth)acrylate, hexanediol di(meth)acrylate, and the like. Among them, trimethylolpropane tri(meth)acrylate, hexanediol di(meth)acrylate, and dipentaerythritol hexa(meth)acrylate can be preferably used. The polyfunctional monomer can be used alone or in combination of two or more.

The content of the polyfunctional monomer, if used, is preferably 3% by weigh or less, more preferably 2% by weight or less, even more preferably 1% by weight or less, based on the total weight of the monomer component used to form the (meth)acryl-based polymer, although it varies with the molecular weight of the monomer, the number of the functional groups, or other conditions. The lower limit of the content is preferably, but not limited to, 0% by weight or more, more preferably 0.001% by weight or more. When the content of the polyfunctional monomer falls within the range, higher adhering strength can be obtained.

The (meth)acryl-based polymer described above can be produced using a method appropriately selected from known production methods, such as solution polymerization, radiation polymerization such as UV polymerization, bulk polymerization, and various radical polymerization methods including emulsion polymerization. The resultant (meth)acryl-based polymer may be any of a random copolymer, a block copolymer, a graft copolymer, or any other form.

Any appropriate polymerization initiator, chain transfer agent, emulsifying agent and so on may be selected and used for radical polymerization. The weight average molecular weight of the (meth)acrylic polymer may be controlled by the reaction conditions including the amount of addition of the polymerization initiator or the chain transfer agent. The amount of the addition may be controlled as appropriate depending on the type of these materials.

In a solution polymerization process and so on, for example, ethyl acetate, toluene or the like is used as a polymerization solvent. In a specific solution polymerization process, for example, the reaction is performed under a stream of inert gas such as nitrogen at a temperature of about 50 to about 70° C. for about 5 to about 30 hours in the presence of a polymerization initiator.

Examples of the thermal polymerization initiator used for the solution polymerization process include, but are not limited to, azo initiators such as 2,2′-azobisisobutyronitrile, 2,2-azobis-2-methylbutyronitrile, 2,2-azobis(2-methylpropionic acid) dimethyl, 4,4′-azobis-4-cyanovaleric acid, azobisisovaleronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (VA-057, manufactured by Wako Pure Chemical Industries, Ltd.); persulfates such as potassium persulfate and ammonium persulfate; peroxide initiators such as di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutylperoxy-2-ethyl hexanoate, di(4-methylbenzoyl)peroxide, dibenzoyl peroxide, tert-butylperoxyisobutylate, 1,1-di(tert-hexylperoxy)cyclohexane, tert-butylhydroperoxide, and hydrogen peroxide; and redox system initiators of a combination of a peroxide and a reducing agent, such as a combination of a persulfate and sodium hydrogen sulfite and a combination of a peroxide and sodium ascorbate.

One of the above polymerization initiators may be used alone, or two or more thereof may be used in a mixture. The content of the polymerization initiator is preferably about 1 part by weight or less, more preferably from about 0.005 to 1 part by weight, even more preferably from about 0.02 to about 0.5 parts by weight, based on 100 parts by total weight of the monomer component.

For example, when 2,2′-azobisisobutyronitrile is used as a polymerization initiator for the production of the (meth)acryl-based polymer with the above weight average molecular weight, the polymerization initiator is preferably used in a content of about 0.2 parts by weight or less, more preferably of from about 0.06 to about 0.2 parts by weight, based on 100 parts by total weight of the monomer component.

Examples of the chain transfer agent include lauryl mercaptan, glycidyl mercaptan, mercaptoacetic acid, 2-mercaptoethanol, thioglycolic acid, 2-ethylhexyl thioglycolate and 2,3-dimercapto-1-propanol. One of these chain transfer agents may be used alone, or two or more thereof may be used in a mixture. The total content of the chain transfer agent is preferably about 0.1 parts by weight or less, based on 100 parts by total weight of the monomer component.

Examples of the emulsifier used in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone, or two or more thereof may be used in combination.

The emulsifier may be a reactive emulsifier. Examples of such an emulsifier having an introduced radical-polymerizable functional group such as a propenyl group and an allyl ether group include Aqualon HS-10, HS-20, KH-10, BC-05, BC-10, and BC-20 (each manufactured by Dai-ichi Kogyo Seiyaku Co., Ltd.) and Adekaria Soap SE10N (manufactured by ADEKA COORPORATION). The reactive emulsifier is preferred, because after polymerization, it can be incorporated into a polymer chain to improve water resistance. Based on 100 parts by total weight of the monomer component, the emulsifier is preferably used in a content of 5 parts by weight or less, more preferably of 0.3 to 5 parts by weight, furthermore preferably of 0.5 to 1 part by weight, in view of polymerization stability or mechanical stability.

The (meth)acryl-based polymer can also be produced by radiation polymerization, in which radiation, such as electron beams or UV rays, is applied to the monomer component. When electron beams are used in the radiation polymerization, there is no particular need to add a photopolymerization initiator to the monomer component. When UV polymerization is used as the radiation polymerization, however, a photopolymerization initiator may be added to the monomer component, which is advantageous particularly in that the polymerization time can be reduced. Any of the photopolymerization initiators may be used alone or in combination of two or more.

The photopolymerization initiator is not particularly limited as long as it can initiate photopolymerization, and photopolymerization initiators that are usually used can be employed. Examples thereof that can be used include benzoin ether-based photopolymerization initiator, acetophenone-based photopolymerization initiator, α-ketol-based photopolymerization initiator, aromatic sulfonyl chloride-based photopolymerization initiator, photoactive oxime-based photopolymerization initiator, benzoin-based photopolymerization initiator, benzyl-based photopolymerization initiator, benzophenone-based photopolymerization initiator, ketal-based photopolymerization initiator, thioxanthone-based photopolymerization initiator, acylphosphine oxide-based photopolymerization initiator, and the like.

Specific examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one (trade name: IRGACURE 651, manufactured by BASF), anisoin methyl ether, and the like. Examples of the acetophenone-based photopolymerization initiator include 1-hydroxycyclohexyl phenyl ketone (trade name: IRGACURE 184, manufactured by BASF), 4-phenoxydichloroacetophenone, 4-t-butyl-dichloroacetophenone, 1-[4-(2-hydroxyethoxy)-phenyl]-2-hydroxy-2-methyl-1-propan-1-one (trade name: IRGACURE 2959, manufactured by BASF), 2-hydroxy-2-methyl-1-phenyl-propan-1-one(tradename:DAROCUR 1173, manufactured by BASF), methoxyacetophenone, and the like. Examples of the α-ketol-based photopolymerization initiator include 2-methyl-2-hydroxypropiophenone, 1-[4-(2-hydroxyethyl)-phenyl]-2-hydroxy-2-methylpropan-1-on e, and the like. Examples of the aromatic sulfonyl chloride-based photopolymerization initiator include 2-naphthalene sulfonyl chloride and the like. Examples of the photoactive oxime-based photopolymerization initiator include 1-phenyl-1,2-propanedione-2-(O-ethoxycarbonyl)-oxime, and the like.

Examples of the benzoin-based photopolymerization initiator include benzoin and the like. Examples of the benzyl-based photopolymerization initiator include benzyl and the like. Examples of the benzophenone-based photopolymerization initiators include benzophenone, benzoylbenzoic acid, 3,3′-dimethyl-4-methoxybenzophenone, polyvinyl benzophenone, α-hydroxycyclohexyl phenyl ketone, and the like. Examples of the ketal-based photopolymerization initiator include benzyl dimethyl ketal and the like. Examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, dodecylthioxanthone and the like.

Examples of the acylphosphine oxide-based photopolymerization initiator include bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl) (2-methylpropan-1-yl)phosphine oxide, bis(2-methoxybenzoyl)(1-methylpropan-1-yl)phosphine oxide, bis(2,6-diethoxybenzoyl)(2-methylpropan-1-yl)phosphine oxide, bis(2,6-diethoxybenzoyl)(1-methylpropan-1-yl)phosphine oxide, bis(2,6-dibutoxybenzoyl)(2-methylpropan-1-yl)phosphine oxide, bis(2,4-dimethoxybenzoyl)(2-methylpropan-1-yl)phosphine oxide, bis(2,4,6-trimethylbenzoyl)(2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, tri(2-methylbenzoyl)phosphine oxide, and the like.

The content of the polymerization initiator is not particularly limited, but is preferably 0.01 to 5 parts by weight, more preferably 0.05 to 3 parts by weight, furthermore preferably 0.05 to 1.5 parts by weight, and particularly preferably 0.1 to 1 part by weight, based on 100 parts by total weight of the monomer component.

When the content of the photopolymerization initiator falls within the range, the polymerization reaction can be allowed to proceed to a sufficient extent. Any of the photopolymerization initiators may be used alone or in combination of two or more.

The (meth)acryl-based polymer for use in the invention preferably has a weight average molecular weight of 400,000 to 2,500,000, more preferably 600,000 to 2,200,000. When its weight average molecular weight is at least 400,000, the resulting pressure-sensitive adhesive layer can have a sufficient level of durability, or the cohesive strength of the resulting pressure-sensitive adhesive layer can be reduced to prevent adhesive residue. As used herein, the term “weight average molecular weight” refers to the polystyrene-equivalent weight average molecular weight determined by gel permeation chromatography (GPC) using polystyrene calibration. It should be noted that the molecular weight of the (meth)acryl-based polymer obtained by radiation polymerization would be difficult to measure.

### <Measurement of Weight Average Molecular Weight>

The weight average molecular weight of the obtained (meth)acryl-based polymer was measured by gel permeation chromatography (GPC) as follows. The polymer sample was dissolved in tetrahydrofuran to form a 0.1% by weight solution. After allowed to stand overnight, the solution was filtered through a 0.45 μm membrane filter, and the filtrate was used for the measurement.

Analyzer: HLC-8120GPC manufactured by TOSOH CORPORATION
Columns: (meth)acryl-based polymer, GM7000H_{XL}+GMH_{XL}+GMH_{XL}, manufactured by TOSOH CORPORATION
Column size: each 7.8 mmφ×30 cm, 90 cm in total
Eluent: tetrahydrofuran (concentration 0.1% by weight)
Flow rate: 0.8 ml/minute
Inlet pressure: 1.6 MPa
Detector: differential refractometer (RI)
Column temperature: 40° C.
Injection volume: 100 μl
Standard sample: polystyrene

The pressure-sensitive adhesive of the invention may contain a crosslinking agent. Examples of the crosslinking agents include an isocyanate crosslinking agent, an epoxy crosslinking agent, a silicone crosslinking agent, an oxazoline crosslinking agent, an aziridine crosslinking agent, a silane crosslinking agent, an alkyl etherified melamine crosslinking agent, a metallic chelate crosslinking agent and a peroxide. Such crosslinking agents may be used alone or in combination of two or more. An isocyanate crosslinking agent or an epoxy crosslinking agent is preferably used as the crosslinking agent.

These crosslinking agents may be used alone or in a mixture of two or more. The total content of the crosslinking agent (s) is preferably 5 parts by weight or less, more preferably 0.001 to 5 parts by weight, even more preferably 0.001 to 4 parts by weight, still more preferably 0.001 to 3 parts by weight, based on 100 parts by weight of the (meth)acryl-based polymer.

The term “isocyanate crosslinking agent” refers to a compound having two or more isocyanate groups (which may include functional groups that are temporarily protected with an isocyanate blocking agent or by oligomerization and are convertible to isocyanate groups) per molecule.

Isocyanate crosslinking agents include aromatic isocyanates such as tolylene diisocyanate and xylene diisocyanate, alicyclic isocyanates such as isophorone diisocyanate, and aliphatic isocyanates such as hexamethylene diisocyanate.

More specifically, examples of isocyanate crosslinking agents include lower aliphatic polyisocyanates such as butylene diisocyanate and hexamethylene diisocyanate; alicyclic isocyanates such as cyclopentylenediisocyanate, cyclohexylene diisocyanate, and isophorone diisocyanate; aromatic diisocyanates such as 2,4-tolylene diisocyanate, 4,4′-diphenylmethane diisocyanate, xylylene diisocyanate, and polymethylene polyphenyl isocyanate; isocyanate adducts such as a trimethylolpropane-tolylene diisocyanate trimer adduct (trade name: CORONATE L, manufactured by NIPPON POLYURETHANE INDUSTRY CO., LTD.), a trimethylolpropane-hexamethylene diisocyanate trimer adduct (trade name: CORONATE HL, manufactured by NIPPON POLYURETHANE INDUSTRY CO., LTD.), and an isocyanurate of hexamethylene diisocyanate (trade name: CORONATE HX, manufactured by NIPPON POLYURETHANE INDUSTRY CO., LTD.); a trimethylolpropane adduct of xylylene diisocyanate (trade name: D110N, manufactured by Mitsui Chemicals, Inc.) and a trimethylolpropane adduct of hexamethylene diisocyanate (trade name: D160N, manufactured by Mitsui Chemicals, Inc.); polyether polyisocyanate and polyester polyisocyanate; adducts thereof with various polyols; and polyisocyanates polyfunctionalized with an isocyanurate bond, a biuret bond, an allophanate bond, or the like. In particular, aliphatic isocyanates are preferably used because of their high reaction speed.

These isocyanate crosslinking agents may be used alone or in a mixture of two or more. The total content of the isocyanate crosslinking agent (s) is preferably 5 parts by weight or less, more preferably 0.01 to 5 parts by weight, even more preferably 0.01 to 4 parts by weight, still more preferably 0.02 to 3 parts by weight, based on 100 parts by weight of the (meth)acryl-based polymer. The content may be appropriately determined taking into account cohesive strength, the ability to prevent delamination in a durability test, or other properties.

When an aqueous dispersion of a modified (meth)acryl-based polymer produced by emulsion polymerization is used, the isocyanate crosslinking agent does not have to be used. If necessary, however, a blocked isocyanate crosslinking agent may also be used in such a case, because the isocyanate crosslinking agent itself can easily react with water.

The term “epoxy crosslinking agent” refers to a polyfunctional epoxy compound having two or more epoxy groups per molecule. Examples of the epoxy crosslinking agent include bisphenol A, epichlorohydrin-type epoxy resin, ethylene glycol diglycidyl ether, N,N,N′,N′-tetraglycidyl-m-xylenediamine, diglycidylaniline, N,N-diamino glycidyl amine, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, glycerine diglycidyl ether, glycerine triglycidyl ether, polyglycerol polyglycidyl ether, sorbitan polyglycidyl ether, trimethylolpropane polyglycidyl ether, diglycidyl adipate, diglycidyl o-phthalate, triglycidyl tris(2-hydroxyethyl)isocyanurate, resorcin diglycidyl ether, bisphenol-S diglycidyl ether, and epoxy resins having two or more epoxy groups in the molecule. The epoxy crosslinking agent may also be a commercially available product such as TETRAD-C (trade name) or TETRAD-X (trade name) manufactured by MITSUBISHI GAS CHEMICAL COMPANY, INC.

These epoxy crosslinking agents may be used alone or in a mixture of two or more. The total content of the epoxy crosslinking agent (s) is preferably 5 parts by weight or less, more preferably 0.01 to 5 parts by weight, even more preferably 0.01 to 4 parts by weight, still more preferably 0.02 to 3 parts by weight, based on 100 parts by weight of the (meth)acryl-based polymer. The content may be appropriately determined taking into account cohesive strength, the ability to prevent delamination in a durability test, or other properties.

Any peroxide crosslinking agents capable of generating active radical species by heating and promoting the crosslinking of the base polymer in the pressure-sensitive adhesive may be appropriately used. In view of workability and stability, a peroxide with a one-minute half-life temperature of 80° C. to 160° C. is preferably used, and a peroxide with a one-minute half-life temperature of 90° C. to 140° C. is more preferably used.

Examples of the peroxide for use in the invention include di(2-ethylhexyl)peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoylperoxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), tert-butyl peroxyisobutylate (one-minute half-life temperature: 136.1° C.), and 1,1-di(tert-hexylperoxy)cyclohexane (one-minute half-life temperature: 149.2° C.). In particular, di(4-tert-butylcyclohexyl)peroxydicarbonate (one-minute half-life temperature: 92.1° C.), dilauroyl peroxide (one-minute half-life temperature: 116.4° C.), dibenzoyl peroxide (one-minute half-life temperature: 130.0° C.), or the like is preferably used, because they can provide high crosslinking reaction efficiency.

The half life of the peroxide is an indicator of how fast the peroxide can be decomposed and refers to the time required for the amount of the peroxide to reach one half of its original value. The decomposition temperature required for a certain half life and the half life time obtained at a certain temperature are shown in catalogs furnished by manufacturers, such as “Organic Peroxide Catalog, 9th Edition, May, 2003” furnished by NOF CORPORATION.

One of the peroxide crosslinking agents may be used alone, or a mixture of two or more of the peroxide crosslinking agent may be used. The total content of the peroxide (s) is preferably 2 parts by weight or less, more preferably from 0.02 to 2 parts by weight, even more preferably from 0.05 to 1 part by weight, based on 100 parts by weight of the (meth)acrylic polymer. The content of the peroxide (s) may be appropriately selected in this range in order to control the workability, reworkability, crosslink stability or peeling properties.

The amount of decomposition of the peroxide may be determined by measuring the peroxide residue after the reaction process by high performance liquid chromatography (HPLC).

More specifically, for example, after the reaction process, about 0.2 g of each pressure-sensitive adhesive composition is taken out, immersed in 10 ml of ethyl acetate, subjected to shaking extraction at 25° C. and 120 rpm for 3 hours in a shaker, and then allowed to stand at room temperature for 3 days. Thereafter, 10 ml of acetonitrile is added, and the mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

As the crosslinking agent, a polyfunctional metal chelate may also be used in combination with an organic crosslinking agent. Examples of the polyfunctional metal chelate may include a polyvalent metal and an organic compound that is covalently or coordinately bonded to the metal. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include alkyl esters, alcohol compounds, carboxylic acid compounds, ether compounds, and ketone compounds.

The pressure-sensitive adhesive of the invention may contain a (meth)acryl-based oligomer in view of improving adhesive strength. The (meth)acryl-based oligomer is preferably a polymer having a Tg higher than that of the (meth)acryl-based polymer according to the invention and having a weight average molecular weight lower than that of the (meth)acryl-based polymer according to the invention. The (meth)acryl-based oligomer functions as a tackifying resin and is advantageous in increasing adhering strength without raising dielectric constant, although it is not essential for the invention. The pressure-sensitive adhesive with no (meth)acryl-based oligomer can have its sebum-induced swelling rate kept at a lower level.

The (meth)acryl-based oligomer may have a Tg of from about 0° C. to about 300° C., preferably from about 20° C. to about 300° C., more preferably from about 40° C. to about 300° C. When the Tg falls within the range, the adhering strength can be improved. Like the Tg of the (meth)acryl-based polymer, the Tg of the (meth)acryl-based oligomer is the theoretical value calculated from the Fox equation.

The Tg of each homopolymer shall be the value listed in Polymer Handbook, 3rd Edition, John Wiley & Sons, Inc, 1989. If two or more different values are listed for a monomer in the handbook, the highest value shall be used.

If not found in Polymer Handbook, 3rd Edition, John Wiley & Sons, Inc, 1989, the value to be used shall be obtained by the measurement method described below (see JP-A-2007-51271).

Specifically, 100 parts by weight of the monomer, 0.2 parts by weight of azobisisobutyronitrile, and 200 parts by weight of ethyl acetate as a polymerization solvent are added to a reaction vessel equipped with a thermometer, a stirrer, a nitrogen-introducing tube, and a reflux condenser, and the mixture is stirred for 1 hour under a nitrogen gas flow. After oxygen is purged from the polymerization system in this manner, the mixture is heated to 63° C. and allowed to react for 10 hours. The reaction mixture is then cooled to room temperature, resulting in a homopolymer solution with a solid concentration of 33% by weight. The homopolymer solution is then applied by casting to a release liner and dried to form a test sample (a sheet of the homopolymer) with a thickness of about 2 mm. The test sample is stamped into a disc with a diameter of 7.9 mm. The disc is sandwiched between parallel plates and measured for viscoelasticity in a shear mode at a rate of temperature rise of 5° C./minute in the temperature range of −70 to 150° C. while shear strain at a frequency of 1 Hz is applied to the disc using a viscoelastic tester (trade name: ARES, manufactured by Rheometric Scientific, Inc.). The Tg of the homopolymer is defined as the peak top temperature at tan 8 (loss tangent).

The (meth)acryl-based oligomer may have a weight average molecular weight of from 1,000 to less than 30,000, preferably from 1,500 to less than 20,000, more preferably from 2,000 to less than 10,000. Setting the weight average molecular weight within the range is preferred in obtaining good adhering strength and good holding properties. In the invention, the weight average molecular weight of the (meth)acryl-based oligomer can be determined as a polystyrene-equivalent weight average molecular weight by GPC method. More specifically, the weight average molecular weight can be determined using HPLC 8020 with two TSKgel GMH-H (20) columns manufactured by TOSOH CORPORATION under the conditions of a solvent of tetrahydrofuran and a flow rate of about 0.5 ml/minute.

Examples of monomers that may be used to form the (meth)acryl-based oligomer include alkyl(meth)acrylate such as methyl(meth)acrylate, ethyl(meth)acrylate, propyl(meth)acrylate, isopropyl(meth)acrylate, butyl(meth)acrylate, isobutyl(meth)acrylate, sec-butyl(meth)acrylate, tert-butyl(meth)acrylate, pentyl(meth)acrylate, isopentyl(meth)acrylate, hexyl(meth)acrylate, 2-ethylhexyl(meth)acrylate, heptyl(meth)acrylate, octyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, or dodecyl(meth)acrylate; an ester of (meth)acrylic acid and an alicyclic alcohol, such as cyclohexyl(meth)acrylate, isobornyl(meth)acrylate or dicyclopentanyl(meth)acrylate; aryl(meth)acrylate such as phenyl(meth)acrylate or benzyl(meth)acrylate; and a (meth)acrylate derived from a terpene compound derivative alcohol. These (meth)acrylates may be used alone or in combination of two or more.

The (meth)acryl-based oligomer preferably contains, as a monomer unit, an acrylic monomer having a relatively bulky structure, typified by an alkyl(meth)acrylate whose alkyl group has a branched structure, such as isobutyl(meth)acrylate or tert-butyl(meth)acrylate; an ester of (meth)acrylic acid and an alicyclic alcohol, such as cyclohexyl(meth)acrylate, isobornyl(meth)acrylate or dicyclopentanyl(meth)acrylate; or aryl(meth)acrylate such as phenyl(meth)acrylate or benzyl(meth)acrylate, or any other cyclic structure-containing (meth)acrylate. The use of a (meth)acryl-based oligomer with such a bulky structure can further improve the tackiness of the pressure-sensitive adhesive layer. When ultraviolet (UV) light is used in the process of synthesizing the (meth)acryl-based oligomer or forming the pressure-sensitive adhesive layer, a saturated oligomer is preferred because such an oligomer is less likely to inhibit polymerization, and an alkyl(meth)acrylate whose alkyl group has a branched structure or an ester of an alicyclic alcohol and (meth)acrylic acid is preferably used as a monomer to form the (meth)acryl-based oligomer.

From these points of view, preferred examples of the (meth)acryl-based oligomer include a copolymer of cyclohexyl methacrylate (CHMA) and isobutyl methacrylate (IBMA), a copolymer of cyclohexyl methacrylate (CHMA) and isobornyl methacrylate (IBXMA), a copolymer of cyclohexyl methacrylate (CHMA) and acryloyl morpholine (ACMO), a copolymer of cyclohexyl methacrylate (CHMA) and diethylacrylamide (DEAA), a copolymer of 1-adamanthyl acrylate (ADA) and methyl methacrylate (MMA), a copolymer of dicyclopentanyl methacrylate (DCPMA) and isobornyl methacrylate (IBXMA), a copolymer of dicyclopentanyl methacrylate (DCPMA) and methyl methacrylate (MMA), and a homopolymer of each of dicyclopentanyl methacrylate (DCPMA), cyclohexylmethacrylate (CHMA), isobornyl methacrylate (IBXMA), isobornyl acrylate (IBXA), dicyclopentanyl acrylate (DCPA), 1-adamanthyl methacrylate (ADMA), and 1-adamanthyl acrylate (ADA). In particular, an oligomer composed mainly of MMA is preferred, a copolymer of dicyclopentanyl methacrylate (DCPMA) and methyl methacrylate (MMA) is more preferred.

When the (meth)acryl-based oligomer is used in the pressure-sensitive adhesive of the invention, the content of the (meth)acryl-based oligomer is preferably, but not limited to, 10 parts by weight or less, more preferably 5 parts by weight or less, even more preferably 3 parts by weight or less, based on 100 parts by weight of the (meth)acryl-based polymer. Setting the content of the (meth)acryl-based oligomer within the range is preferred in lowering the sebum-induced swelling rate.

The pressure-sensitive adhesive of the invention may further contain a silane coupling agent for improving water resistance at the interface between the pressure-sensitive adhesive layer and a hydrophilic adherend, such as glass, bonded thereto. The content of the silane coupling agent is preferably 1 part by weight or less, more preferably from 0.01 to 1 part by weight, even more preferably from 0.02 to 0.6 parts by weight, based on 100 parts by weight of the (meth)acryl-based polymer. Setting the content of the silane coupling agent within the range is preferred in achieving both good peeling property and good durability.

Examples of silane coupling agent preferably can be used include epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropylmethyldimethoxysilane, 3-triethoxysilyl-N-(1,3-dimethylbutylidene)propylamine and N-phenyl-γ-aminopropyltrimethoxysilane; (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane.

The pressure-sensitive adhesive of the invention may also contain any other known additive. For example, a powder such as a colorant and a pigment, a dye, a surfactant, a plasticizer, a tackifier, a surface lubricant, a leveling agent, a softening agent, an antioxidant, an age resister, a light stabilizer, an ultraviolet absorbing agent, a polymerization inhibitor, an inorganic or organic filler, a metal powder, or a particle- or foil-shaped material may be added as appropriate depending on the intended use.

### 2. Pressure-Sensitive Adhesive Layer and Pressure-Sensitive Adhesive Sheet

The pressure-sensitive adhesive layer of the invention is made from the pressure-sensitive adhesive described above. The thickness of the pressure-sensitive adhesive layer is typically, but not limited to, about 1 to about 400 μm. The preferred range of the thickness of the pressure-sensitive adhesive layer may be appropriately determined depending on the method of producing the (meth)acryl-based polymer used to form the pressure-sensitive adhesive. For example, when the (meth)acryl-based polymer is produced by solution polymerization or the like, the thickness of the pressure-sensitive adhesive layer is preferably from 1 to 100 μm, more preferably from 2 to 50 μm, even more preferably from 2 to 40 μm, still more preferably from 5 to 35 μm. When the (meth)acryl-based polymer is produced by radiation polymerization or the like, the thickness of the pressure-sensitive adhesive layer is preferably from 50 to 400 μm, more preferably from 75 to 300 μm, even more preferably from 100 to 200 μm.

The pressure-sensitive adhesive layer of the invention preferably has a gel fraction of 95% by weight or less, more preferably 20 to 95% by weight, even more preferably 50 to 95% by weight. When the pressure-sensitive adhesive contains a crosslinking agent, the gel fraction can be controlled by adjusting the total content of the crosslinking agent in careful consideration of the effect of the crosslinking temperature or the crosslinking time. The pressure-sensitive adhesive layer with such a gel fraction is characterized by having high resistance to sebum, showing only a very low level of adhering strength increase after it is bonded to adherends, and being easily removable without adhesive residue even after it remains bonded for a long period of time.

The pressure-sensitive adhesive layer of the invention preferably has a haze value of 2% or less when having a thickness of 100 μm. The pressure-sensitive adhesive layer with a haze value of 2% or less can satisfy the requirements for transparency when it is used on optical members. The haze value is preferably from 0 to 1.5%, more preferably from 0 to 1%. A haze value of 2% or less is a satisfactory level for optical applications.

The transparency of the pressure-sensitive adhesive layer is considered to depend on the total content of the hydroxyl group-containing monomer and the cyclic nitrogen-containing monomer based on the total amount of the monomer component. If the total content is high, the transparency can be high, but too high a total content may have an adverse effect on other properties. Therefore, for example, when the content of the cyclic nitrogen-containing monomer is low, the transparency can be controlled using the hydroxyl group-containing monomer.

The pressure-sensitive adhesive layer of the invention preferably has a sebum-induced swelling rate of 1.4 or less, more preferably 1.3 or less, even more preferably less than 1.2, still more preferably less than 1.1. The lower sebum-induced swelling rate the better, while the sebum-induced swelling rate is ideally 1.0. The sebum-induced swelling rate is determined by the method described in the section “EXAMPLES.”

For example, the pressure-sensitive adhesive layer may be formed by a method including applying the pressure-sensitive adhesive to a support, removing the polymerization solvent and so on by drying to form a pressure-sensitive adhesive sheet. Before the pressure-sensitive adhesive is applied, appropriately at least one solvent other than the polymerization solvent may be added to the pressure-sensitive adhesive.

Various methods may be used to apply the pressure-sensitive adhesive layer. Specific examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

The heat drying temperature is preferably from 40° C. to 200° C., more preferably from 50° C. to 180° C., in particular, preferably from 70° C. to 170° C. Setting the heating temperature within the above range makes it possible to obtain a pressure-sensitive adhesive layer having good adhesive properties. The drying time may be any appropriate period of time. The drying time is preferably from 5 seconds to 20 minutes, more preferably from 5 seconds to 10 minutes, in particular, preferably from 10 seconds to 5 minutes.

When the (meth)acryl-based polymer according to the invention is produced by ultraviolet irradiation of the monomer component to be polymerized, the pressure-sensitive adhesive layer may be formed while the (meth)acryl-based polymer is produced from the monomer component. Appropriate materials such as a crosslinking agent and other materials that may be added to the pressure-sensitive adhesive may also be mixed with the monomer component. Before the ultraviolet irradiation, the monomer component may be partially polymerized to form a syrup before use. The ultraviolet irradiation may be performed using a high-pressure mercury lamp, a low-pressure mercury lamp, a metal halide lamp, or the like.

For example, a release-treated sheet may be used as the support. A silicone release liner is preferably used as the release-treated sheet.

In the pressure-sensitive adhesive sheet containing the layer pressure-sensitive adhesive layer formed on the release-treated sheet, when the pressure-sensitive adhesive layer is exposed, the pressure-sensitive adhesive layer may be protected with the release-treated sheet (a separator) before practical use. The release-treated sheet is peeled off before actual use.

Examples of the material for forming the separator include a plastic film such as a polyethylene, polypropylene, polyethylene terephthalate, or polyester film, a porous material such as paper, cloth and nonwoven fabric, and an appropriate thin material such as a net, a foamed sheet, a metal foil, and a laminate thereof. In particular, a plastic film is preferably used, because of its good surface smoothness.

The plastic film may be any film capable of protecting the pressure-sensitive adhesive layer, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the separator is generally from about 5 to about 200 μm, preferably from about 5 to about 100 μm. If necessary, the separator may be treated with a release agent such as a silicone, fluorine, long-chain alkyl, or fatty acid amide release agent, or may be subjected to release and antifouling treatment with silica powder or to antistatic treatment of coating type, kneading and mixing type, vapor-deposition type, or the like. In particular, if the surface of the separator is appropriately subjected to release treatment such as silicone treatment, long-chain alkyl treatment, and fluorine treatment, the releasability from the pressure-sensitive adhesive layer can be further increased.

The pressure-sensitive adhesive layer and the pressure-sensitive adhesive sheet of the invention are suitable for use on optical members, and particularly in optical applications, they are preferably used and bonded to metal thin layers or metal electrodes. Metal thin layers include thin layers of metal, metal oxide, or a mixture of metal and metal oxide, and examples of metal thin layers include, but are not limited to, thin layers of ITO (indium tin oxide), ZnO, SnO, and CTO (cadmium tin oxide). The thickness of metal thin layers is typically, but not limited to, about 10 to 200 nm. Usually, for example, a metal thin layer such as an ITO layer is provided on a transparent plastic film substrate such as a polyethylene terephthalate film (a PET film) to form a transparent conductive film for use. When the pressure-sensitive adhesive sheet of the invention is bonded to a metal thin layer, the surface of the pressure-sensitive adhesive layer is preferably used as a bonding surface to the metal thin layer.

The metal electrodes may be made of metal, metal oxide, or a mixture of metal and metal oxide, and examples include, but are not limited to, ITO, silver, copper, and carbon nanotube (CNT) electrodes.

A specific example of the use of the pressure-sensitive adhesive sheet of the invention is a touch panel-forming pressure-sensitive adhesive sheet, which is used in the manufacture of a touch panel. For example, the touch panel-forming pressure-sensitive adhesive sheet is used in the manufacture of a capacitance touch panel, where it is used to bond a transparent conductive film having a metal thin layer such as an ITO layer to a poly(methyl methacrylate) (PMMA) resin sheet, a hard-coated film, a glass lens, or any other material. Applications of the touch panel include, but are not limited to, cellular phones, tablet computers, and personal digital assistances.

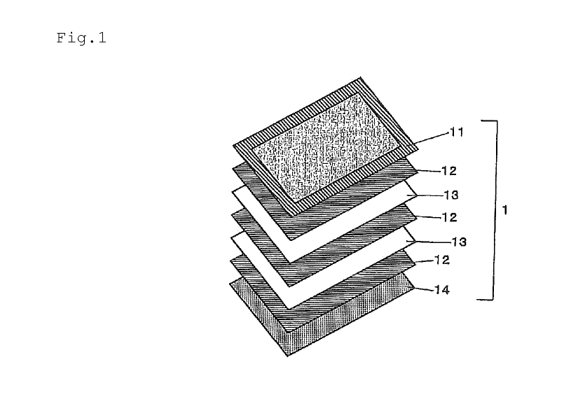

FIG. 1 shows a more specific example of the use of the pressure-sensitive adhesive layer or the pressure-sensitive adhesive sheet of the invention, which is an example of a capacitance touch panel. FIG. 1 shows a capacitance touch panel 1 including a decorative panel 11, pressure-sensitive adhesive layers or pressure-sensitive adhesive sheets 12, ITO films 13, and a hard coated film 14. The decorative panel 11 is preferably a glass plate or a transparent acrylic plate (PMMA plate). Each ITO films 13 preferably includes a glass sheet or a transparent plastic film (specifically, a PET film) and an ITO layer provided thereon. The hard coated film 14 is preferably a hard coated transparent plastic film such as a hard coated PET film. The capacitance touch panel 1 having the pressure-sensitive adhesive layer or the pressure-sensitive adhesive sheet of the invention has high resistance to sebum and can be made thinner and more stable in operation. The capacitance touch panel 1 also has a good appearance and good visibility.

An optical member may be used as the support of the pressure-sensitive adhesive sheet of the invention. The pressure-sensitive adhesive layer can be formed by a process including applying the pressure-sensitive adhesive directly to an optical member and drying the adhesive to remove the polymerization solvent and the like, so that the pressure-sensitive adhesive layer is formed on the optical member. Alternatively, the pressure-sensitive adhesive layer may be formed on a release-treated separator and then transferred to an optical member as needed to form a pressure-sensitive adhesive optical member.

The release-treated sheet used in the preparation of the pressure-sensitive adhesive optical member may be used by itself as a separator for the pressure-sensitive adhesive optical member, so that the process can be simplified.

The process for forming the pressure-sensitive adhesive layer for the pressure-sensitive adhesive optical member may further include forming an anchor layer on the surface of the optical member or performing any adhesion-facilitating treatment such as a corona treatment or a plasma treatment before forming the pressure-sensitive adhesive layer. The surface of the pressure-sensitive adhesive layer may also be subjected to an adhesion-facilitating treatment.

The pressure-sensitive adhesive optical member of the invention may be used as a pressure-sensitive adhesive layer-carrying transparent conductive film, which is produced using a transparent conductive film as an optical member. The transparent conductive film includes a transparent plastic film substrate and a transparent conductive thin layer that is formed of a metal thin layer such as the ITO layer on one surface of the substrate. The pressure-sensitive adhesive layer of the invention is provided on the other surface of the transparent plastic film substrate. The transparent conductive thin layer may be provided on the transparent plastic film substrate with an undercoat layer interposed therebetween. Two or more undercoat layers may be provided. An oligomer migration-preventing layer may be provided between the transparent plastic film substrate and the pressure-sensitive adhesive layer.

The transparent plastic film substrate to be used may be, but not limited to, various transparent plastic films. The plastic film is generally formed of a monolayer film. Examples of the material for the transparent plastic film substrate include polyester resins such as polyethylene terephthalate and polyethylene naphthalate, acetate resins, polyethersulfone resins, polycarbonate resins, polyamide resins, polyimide resins, polyolefin resins, (meth)acrylic resins, polyvinyl chloride resins, polyvinylidene chloride resins, polystyrene resins, polyvinyl alcohol resins, polyarylate resins, and polyphenylene sulfide resins. In particular, polyester resins, polyimide resins, and polyethersulfone resins are preferred. The film substrate preferably has a thickness of 15 to 200 μm.

The surface of the film substrate may be previously subject to sputtering, corona discharge treatment, flame treatment, ultraviolet irradiation, electron beam irradiation, chemical treatment, etching treatment such as oxidation, or undercoating treatment such that the adhesion of the transparent conductive thin layer or the undercoat layer formed thereon to the transparent plastic film substrate can be improved. If necessary, the film substrate may also be subjected to dust removing or cleaning by solvent cleaning, ultrasonic cleaning or the like, before the transparent conductive thin layer or the undercoat layer is formed.

The material and thickness of the transparent conductive thin layer are not restricted and may be those described for the metal thin layer. The undercoat layer may be made of an inorganic material, an organic material or a mixture of an inorganic material and an organic material. Examples of the inorganic material include NaF (1.3), Na₃AlF₆ (1.35), LiF (1.36), MgF₂ (1.38), CaF₂ (1.4), BaF₂ (1.3), SiO₂ (1.46), LaF₃ (1.55), CeF₃ (1.63), and Al₂O₃ (1.63), wherein each number inside the parentheses is the refractive index of each material. In particular, SiO₂, MgF₂, Al₂O₃, or the like is preferred, SiO₂ is more preferred. Besides the above, a complex oxide containing about 10 to about 40 parts by weight of cerium oxide and about 0 to about 20 parts by weight of tin oxide based on 100 parts by weight of the indium oxide may also be used.

Examples of the organic material include acrylic resins, urethane resins, melamine resins, alkyd resins, siloxane polymers, and organosilane-based condensates. At least one of these organic materials may be used. In particular, a thermosetting resin including a mixture composed of a melamine resin, an alkyd resin and an organosilane condensate is preferably used as the organic material.

The thickness of the undercoat layer is generally, but not limited to, from about 1 to about 300 nm, preferably from 5 to 300 nm, in view of optical design and the effect of preventing the release of an oligomer from the film substrate.

The pressure-sensitive adhesive layer-carrying transparent conductive film can be used to form various devices such as touch panels and liquid crystal display devices. In particular, the pressure-sensitive adhesive layer-carrying transparent conductive film is preferably used as a touch panel-forming electrode sheet. The touch panel is suitable for use in different types of detection (such as resistive and capacitance types).

A capacitance touch panel usually includes a transparent conductive film that has a transparent conductive thin layer in a specific pattern and is formed over the surface of a display unit. The pressure-sensitive adhesive layer-carrying transparent conductive film is a laminate in which the pressure-sensitive adhesive layer and the patterned transparent conductive thin layer are appropriately stacked facing each other.

The pressure-sensitive adhesive optical member of the invention may be used as a pressure-sensitive adhesive layer-carrying optical film, which is produced using an image display-forming optical film as the optical member.

The optical film may be of any type for use in forming image display devices such as liquid crystal display devices and organic electro-luminescent (EL) display devices. For example, a polarizing plate is exemplified as the optical film. A polarizing plate including a polarizer and a transparent protective film provided on one or both sides of the polarizer is generally used.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type alignment films, such as dehydrated polyvinyl alcohol and dehydrochlorinated polyvinyl chloride, etc. may be mentioned. In these, a polyvinyl alcohol type film on which dichromatic materials such as iodine, is absorbed and aligned after stretched is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and/or potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, even more preferably from 60 to 98% by weight, still more preferably from 70 to 97% by weight. Setting the content of the thermoplastic resin in the transparent protective film within the range is preferred in sufficiently providing the inherent high transparency of the thermoplastic resin.

Further an optical film may be used as other optical layers, such as a reflective plate, a transflective plate, a retardation plate (a half wavelength plate and a quarter wavelength plate included), an optical compensation film, a viewing angle compensation film and a brightness enhancement film, which may be used for formation of a liquid crystal display device etc. These are used in practice as an optical film, or as one layer or two layers or more of optical layers laminated with polarizing plate.

Although an optical film with the above described optical layer laminated to the polarizing plate may be formed by a method in which laminating is separately carried out sequentially in manufacturing process of a liquid crystal display device etc., an optical film in a form of being laminated beforehand has an outstanding advantage that it has excellent stability in quality and assembly workability, etc., and thus manufacturing processes ability of a liquid crystal display device etc. may be raised. Proper adhesion means, such as a pressure-sensitive adhesive layer, may be used for laminating. On the occasion of adhesion of the above described polarizing plate and other optical layers, the optical axis may be set as a suitable configuration angle according to the target retardation characteristics etc.

The pressure-sensitive adhesive layer-carrying optical film of the invention is preferably used to form various types of image display devices such as liquid crystal display devices. Liquid crystal display devices may be formed according to conventional techniques. Specifically, liquid crystal display devices are generally formed by appropriately assembling a liquid crystal cell and the pressure-sensitive adhesive layer-carrying optical film and optionally other component such as alighting system and incorporating a driving circuit according to any conventional technique, except that the pressure-sensitive layer-carrying adhesive optical film of the invention is used. Any type of liquid crystal cell may also be used such as a TN type, an STN type, a n type, a VA type and IPS type.

Suitable liquid crystal display devices, such as liquid crystal display device with which the pressure-sensitive adhesive layer-carrying optical film has been located at one side or both sides of the liquid crystal cell, and with which a backlight or a reflective plate is used for a lighting system may be manufactured. In this case, the optical film may be installed in one side or both sides of the liquid crystal cell. When installing the optical films in both sides, they may be of the same type or of different type. Furthermore, in assembling a liquid crystal display device, suitable parts, such as diffusion plate, anti-glare layer, antireflection film, protective plate, prism array, lens array sheet, optical diffusion plate, and backlight, may be installed in suitable position in one layer or two or more layers.

The pressure-sensitive adhesive layer or the pressure-sensitive adhesive sheet of the invention is suitable for use in optical applications. For example, the pressure-sensitive adhesive layer or the pressure-sensitive adhesive sheet of the invention is suitable for use in the manufacture of image display devices such as liquid crystal display devices, organic electroluminescence (EL) display devices, plasma display panels (PDPs), and electronic paper, and is also suitable for use in the manufacture of input devices such as touch panels including optical, ultrasonic, capacitance, and resistive types. In particular, the pressure-sensitive adhesive layer or the pressure-sensitive adhesive sheet of the invention is advantageously used in capacitance touch panels.

The pressure-sensitive adhesive sheet of the invention is also useful as a pressure-sensitive adhesive optical member, in which an optical member is used as a support. For example, when a transparent conductive film is used as the optical member, the pressure-sensitive adhesive optical member can be used as a pressure-sensitive adhesive layer-carrying transparent conductive film. Such a pressure-sensitive adhesive layer-carrying transparent conductive film can be used as a transparent electrode in the image display device or the touch panel mentioned above after it is processed appropriately. In particular, the pressure-sensitive adhesive layer-carrying transparent conductive film with a patterned transparent conductive thin film is advantageously used as an electrode substrate for an input device of a capacitance touch panel. Additionally, the pressure-sensitive adhesive layer-carrying transparent conductive film can be used for prevention of static buildup on transparent products or electromagnetic wave shielding, and to form liquid crystal dimming glass products and transparent heaters.

When an optical film is used as the optical member, the pressure-sensitive adhesive optical member can be used as a pressure-sensitive adhesive layer-carrying optical film. The pressure-sensitive adhesive layer-carrying optical film can be used to form image display devices such as liquid crystal display devices and organic EL display devices. Examples of the optical film to be used include a polarizing plate, a retardation plate, an optical compensation film, a brightness enhancement film, and a laminate of any combination thereof.

### EXAMPLES

Hereinafter, the invention will be more specifically described with reference to examples, which however are not intended to limit the invention. Unless otherwise specified, “parts” and “%” are all by weight in each example.

### Example 1

### Preparation of Monomer Component for Use in UV Polymerization

To a four-neck flask were added 61 parts by weight of 2-ethylhexyl acrylate (2EHA), 14 parts by weight of N-vinyl-2-pyrrolidone (NVP), 0.05 parts by weight of each of two photopolymerization initiators (IRGACURE 184 (trade name) manufactured by BASF and IRGACURE 651 (trade name) manufactured by BASF), so that a monomer mixture was obtained. Subsequently, the monomer mixture was partially photo-polymerized by being exposed to ultraviolet rays in a nitrogen atmosphere, so that a partial polymer (acryl-based polymer syrup) was obtained with a conversion of about 10% by weight.

To the resultant acryl-based polymer syrup (75.1 parts by weight) were added 3 parts by weight of 2-hydroxyethyl acrylate (2HEA), 22 parts by weight of 4-hydroxybutyl acrylate (HBA), and 0.06 parts by weight of dipentaerythritol pentaacrylate (KAYARAD DPHA (trade name) manufactured by Nippon Kayaku Co., Ltd.). Subsequently, these materials were uniformly mixed to form a monomer component.

### <Production of Pressure-Sensitive Adhesive Layer Using UV Polymerization>

Subsequently, a 38-μm-thick polyester film (Diafoil MRF (trade name) manufactured by Mitsubishi Plastics, Inc.) with its one side release-treated with silicone was provided, and the monomer component prepared as described above was applied to the release-treated surface of the polyester film so that a coating layer with a final thickness of 100 μm could be formed. Subsequently, a 38-μm-thick polyester film (Diafoil MRE (trade name) manufactured by Mitsubishi Plastics, Inc.) with its one side release-treated with silicone was provided, and the surface of the applied monomer component was covered with the polyester film in such a manner that the release-treated surface of the film faced the coating layer. As a result, the coating layer of the monomer component was shielded from oxygen. The sheet having the coating layer obtained as described above was irradiated with ultraviolet rays from a chemical light lamp (manufactured by TOSHIBA CORPORATION) at an irradiance of 5 mW/cm² (as measured using TOPCON UVR-T1 having a maximum sensitivity at about 350 nm) for 360 seconds, so that the coating layer was cured to form a pressure-sensitive adhesive layer, and thus a pressure-sensitive adhesive sheet was formed. The polyester films placed over both sides of the pressure-sensitive adhesive layer function as release liners.

### Examples 2 to 14 and Comparative Examples 1 and 2

Pressure-sensitive adhesive sheets were prepared using the same process as in Example 1, except that the monomer type used and the monomer content were changed as shown in Tables 1 to 3.

### Example 15 and Comparative Example 3

Pressure-sensitive adhesive sheets were prepared using the same process as in Example 1, except that the monomer type used and the monomer content were changed as shown in Tables 1 to 3 and that the acrylic oligomer produced by the procedure described below was added to the acryl-based polymer syrup.

### (Preparation of Acrylic Oligomer)

To a separable flask were added 60 parts by weight of methyl methacrylate (MMA, manufactured by MITSUBISHI GAS CHEMICAL COMPANY, INC.) as a monomer, 40 parts by weight of dicyclopentanyl methacrylate (DCPMA, manufactured by Hitachi Chemical Company, Ltd.) as another monomer, 30 parts by weight of α-thioglycerol (manufactured by Tokyo Chemical Industry Co., Ltd.) as a chain transfer agent, 0.2 parts by weight of 2,2′-azobisisobutyronitrile (AIBN, manufactured by KISHIDA CHEMICAL Co., Ltd.) as a polymerization initiator, and 60 parts by weight of ethyl acetate as a polymerization solvent. The mixture was stirred for 1 hour while nitrogen gas was introduced into the flask.

After oxygen was purged from the polymerization system in this manner, the mixture was heated to 70° C. and allowed to react for 2 hours and further allowed to react at 80° C. for 8 hours, so that an oligomer solution with a solid concentration of 60% by weight was obtained. The oligomer solution was dried by heating at 85° C. under a degree of vacuum of 7.5 kPa for 1 hour, so that an oligomer powder with a solid concentration of 100% by weight was obtained.

The pressure-sensitive adhesive sheets obtained in the examples and the comparative examples were evaluated as described below. Tables 1 to 3 show the evaluation results.

### <Measurement of Gel Fraction>

A predetermined amount (initial weight W1) was sampled from the pressure-sensitive adhesive layer of the pressure-sensitive adhesive sheet. The sample was immersed and stored in an ethyl acetate solution at room temperature for 1 week. The insoluble matter was then taken out and measured for dry weight (W2). The gel fraction of the sample was determined from the following formula.

$$Gel fraction ( wt \% ) = \frac{W 2}{W 1} \times 100 \qquad [ math . 1 ]$$

### <Measurement of Haze>

The 100-μm-thick pressure-sensitive adhesive layer obtained in each of the examples and the comparative examples was bonded to one side of a non-alkali glass plate with a haze of 0.1% and then measured for haze using a haze meter (MR-100 manufactured by Murakami Color Research Laboratory). In the measurement using the haze meter, the pressure-sensitive adhesive sheet was placed on the light source side. The haze value of the non-alkali glass plate was 0.1%. Thus, the haze value of the pressure-sensitive adhesive sheet was determined by subtracting 0.1% from the measured value.

### <Sebum-Induced Swelling Rate>

### (Preparation of Sebum Liquid)

Uniformly mixed were 41 parts by weight of triglyceride (Lexol GT-865 (trade name) manufactured by INOLEX), 16.4 parts by weight of isostearic acid (manufactured by Wako Pure Chemical Industries, Ltd.), and 12 parts by weight of squalene (manufactured by Wako Pure Chemical Industries, Ltd.), so that a sebum liquid was obtained.

### (Measurement of Sebum-Induced Swelling Rate)

The pressure-sensitive adhesive sheet obtained in each of the examples and the comparative examples was cut into a piece of 3 cm×3 cm. One side of the cut piece was bonded to one side of. PET, and the pressure-sensitive adhesive surface on the other side was bonded to one side of an alkali glass plate, so that a test piece was obtained. The test piece was immersed in the sebum liquid prepared as described above under the conditions of 50° C. and 95% RH for 120 hours, so that it was allowed to swell. The area (cm²) after the swelling was measured. The sebum-induced swelling rate was calculated from the following formula.

$$Sebum \text{-} induced swelling rate = \frac{Area ( {cm}^{2} ) after swelling}{Original area ( 9 {cm}^{2} )} \qquad [ Math . 2 ]$$

TABLE 1

| | | | Example | | | | | | |
|---|---|---|---|---|---|---|---|---|---|
| | | | 1 | 2 | 3 | 4 | 5 | 6 | 7 |
| Monomer | Monofunctional | 2EHA | 61 | 61 | 61 | 61 | 61 | 61 | |
| component | monomer | BA | | | | | | | 57 |
| | | NVP | 14 | 14 | 14 | 14 | 14 | 14 | |
| | | CHA | | | | | | | 12 |
| | | HEA | 3 | 3 | 3 | 3 | 3 | 3 | 8 |
| | | HBA | 22 | 22 | 22 | 22 | 22 | 22 | 23 |
| | Polyfunctional | DPHA | 0.06 | 0.12 | 0.18 | | | | 0.12 |
| | monomer | HDDA | | | | 0.06 | 0.12 | 0.18 | |

| | | | | | | | | |
|---|---|---|---|---|---|---|---|---|
| Evaluation | Haze | 0.6 | 0.6 | 0.6 | 0.6 | 0.6 | 0.6 | 0.4 |
| results | Gel fraction (wt %) | 90 | 92 | 93 | 93 | 94 | 95 | 86 |
| | Sebum-induced swelling | 1.07 | 1.12 | 1.13 | 1.07 | 1.13 | 1.14 | 1.00 |
| | rate | | | | | | | |

TABLE 2

| | | | Example | | | | | | | |
|---|---|---|---|---|---|---|---|---|---|---|
| | | | 8 | 9 | 10 | 11 | 12 | 13 | 14 | 15 |
| Monomer | Monofunctional | 2EHA | | 65 | 63 | 65 | 63 | 61 | 60 | 60 |
| component | monomer | BA | 67 | | | | | | | |
| | | NVP | | 15 | 14.5 | 15 | 14.5 | 14 | 14 | 14 |
| | | CHA | 14 | | | | | | | |
| | | HEA | 19 | 20 | 22.5 | 3 | 3 | 3 | 26 | 26 |
| | | HBA | | | | 17 | 19.5 | 22 | | |
| | Polyfunctional | DPHA | 0.1 | 0.04 | 0.005 | 0.04 | 0.04 | 0.005 | | |
| | monomer | HDDA | | | | | | | 0.25 | 0.25 |

| Acrylic oligomer | | | | | | | | | 5 |
|---|---|---|---|---|---|---|---|---|---|
| Evaluation | Haze | 0.4 | 0.7 | 0.8 | 0.4 | 0.6 | 0.6 | 1.6 | 1.5 |
| results | Gel fraction (wt %) | 90 | 91 | 91 | 88 | 89 | 88 | — | — |
| | Sebum-induced swelling | 1.00 | 1.09 | 1.08 | 1.14 | 1.09 | 1.05 | 1.06 | 1.14 |
| | rate | | | | | | | | |

TABLE 3

| | | | Comparative Example | | |
|---|---|---|---|---|---|
| | | | 1 | 2 | 3 |
| Monomer | Monofunctional | 2EHA | 72 | 60 | 68 |
| component | monomer | LA | | 11 | |
| | | NVP | 14 | 14 | 14.5 |
| | | IBXA | | | |
| | | HEA | 15 | 15 | 17.5 |
| | Polyfunctional monomer | HDDA | 0.25 | 0.25 | 0.25 |

| Acrylic oligomer | | | | 5 |
|---|---|---|---|---|
| Evaluation | Haze | 0.4 | 0.4 | 0.4 |
| results | Gel fraction (wt %) | — | — | 92 |
| | Sebum-induced swelling rate | 1.91 | 2.37 | 1.48 |

Tables 1 to 3 use the following abbreviations.

2EHA: 2-ethylhexylacrylate (manufactured by TOAGOSEI CO., LTD.)
BA: butyl acrylate (manufactured by TOAGOSEI CO., LTD.)
LA: lauryl acrylate (manufactured by Kyoeisha Chemical Co., Ltd.)
NVP: N-vinyl-2-pyrrolidone (manufactured by NIPPON SHOKUBAI CO., LTD.)
CHA: cyclohexylacrylate (manufactured by Osaka Organic Chemical Industry Ltd.)
IBXA: Isobornyl acrylate (manufactured by Osaka Organic Chemical Industry Ltd.)
HEA: 2-hydroxyethyl acrylate (manufactured by TOAGOSEI CO., LTD.)
HBA: 4-hydroxybutyl acrylate (manufactured by Osaka Organic Chemical Industry Ltd.)
HDDA: 1,6-hexanediol diacrylate
DPHA: Dipentaerythritol hexaacrylate

### DESCRIPTION OF REFERENCE SIGNS

1 Capacitance touch panel
11 Decorative panel
12 Pressure-sensitive adhesive layer or pressure-sensitive adhesive sheet
13 ITO film
14 Hard coated film

What is claimed is:

1. A pressure-sensitive adhesive, comprising a (meth)acryl-based polymer obtained by polymerization of a monomer component containing 40 to 82% by weight of an alkyl(meth)acrylate having an alkyl group of 4 to 18 carbon atoms at an ester end and 18 to 35% by weight of a hydroxyl group-containing monomer.

2. The pressure-sensitive adhesive according to claim 1, wherein the hydroxyl group-containing monomer is hydroxyalkyl(meth)acrylate having a hydroxyalkyl group of 2 to 6 carbon atoms.

3. The pressure-sensitive adhesive according to claim 2, wherein the hydroxyl group-containing monomer is 2-hydroxyethyl(meth)acrylate and/or 4-hydroxybutyl(meth)acrylate.

4. The pressure-sensitive adhesive according to claim 1, wherein the alkyl(meth)acrylate having an alkyl group of 4 to 18 carbon atoms at the ester end is 2-ethylhexyl(meth)acrylate or butyl(meth)acrylate.

5. The pressure-sensitive adhesive according to claim 1, wherein the monomer component further contains a cyclic nitrogen-containing monomer.

6. The pressure-sensitive adhesive according to claim 1, wherein the monomer component further contains 3% by weight or less of a polyfunctional monomer.

7. A pressure-sensitive adhesive layer obtained from the pressure-sensitive adhesive according to claim 1.

8. The pressure-sensitive adhesive layer according to claim 7, which has a gel fraction of 95% by weight or less.

9. The pressure-sensitive adhesive layer according to claim 7, which has a haze of 2% or less when it has a thickness of 100 μm.

10. The pressure-sensitive adhesive layer according to claim 7, which has a sebum-induced swelling rate of less than 1.2.

11. The pressure-sensitive adhesive layer according to claim 7, which is for use on an optical member.

12. A pressure-sensitive adhesive sheet, comprising a support and the pressure-sensitive adhesive layer according to claim 7 formed on at least one side of the support.

13. The pressure-sensitive adhesive sheet according to claim 12, which is a pressure-sensitive adhesive optical member comprising an optical member as the support and the pressure-sensitive adhesive layer provided on at least one side of the optical member.

14. The pressure-sensitive adhesive according to claim 2, wherein the alkyl(meth)acrylate having an alkyl group of 4 to 18 carbon atoms at the ester end is 2-ethylhexyl(meth)acrylate or butyl(meth)acrylate.

15. The pressure-sensitive adhesive according to claim 3, wherein the alkyl(meth)acrylate having an alkyl group of 4 to 18 carbon atoms at the ester end is 2-ethylhexyl(meth)acrylate or butyl(meth)acrylate.

16. The pressure-sensitive adhesive according to claim 2, wherein the monomer component further contains a cyclic nitrogen-containing monomer.

17. The pressure-sensitive adhesive according to claim 3, wherein the monomer component further contains a cyclic nitrogen-containing monomer.

18. The pressure-sensitive adhesive according to claim 4, wherein the monomer component further contains a cyclic nitrogen-containing monomer.

19. The pressure-sensitive adhesive according to claim 2, wherein the monomer component further contains 3% by weight or less of a polyfunctional monomer.

20. The pressure-sensitive adhesive according to claim 3, wherein the monomer component further contains 3% by weight or less of a polyfunctional monomer.
